(19) United States
(12) Patent Application Publication
(10) Pub. No.: US 2022/0286502 A1
(43) Pub. Date: Sep. 8, 2022

(54) COMMUNICATION CONTROL DEVICE, COMMUNICATION SYSTEM, COMMUNICATION CONTROL METHOD, AND RECORDING MEDIUM

(71) Applicant: NEC Corporation, Tokyo (JP)

(72) Inventor: Yota KOGURE, Tokyo (JP)

(73) Assignee: NEC Corporation, Tokyo (JP)

(21) Appl. No.: 17/667,767

(22) Filed: Feb. 9, 2022

(30) Foreign Application Priority Data
Mar. 5, 2021 (JP) 2021-035009

(51) Int. Cl. H04L 67/104; H04L 67/1061

(52) U.S. Cl. CPC H04L 67/1051; H04L 67/1046; H04L 67/1061

(57) ABSTRACT

The present disclosure reduces occurrence of resource shortage and processing delay. A setting unit sets a group including one or more edge computers, a determination unit determines one of the edge computers included in the group as a representative of the group, and a transmission unit transmits an instruction related to control of an IoT device to the representative edge computer.

This application is based upon and claims the benefit of priority from Japanese Patent Application No. 2021-035009, filed on Mar. 5, 2021, the disclosure of which is incorporated herein in its entirety by reference.

### TECHNICAL FIELD

The present invention relates to a communication control device, a communication system, a communication control method, and a recording medium, and more particularly, to a communication control device, a communication system, a communication control method, and a recording medium that control communication on a communication network.

### BACKGROUND ART

In a communication system according to an example of related techniques, a cloud server and an edge computer are wirelessly connected to each other via a wide area network. Furthermore, an Internet of Things (IoT) device and the edge computer are connected to each other wirelessly or by wire via a short-distance network. The edge computer is also called an intermediate server.
Patent Document 1 (JP 2017-146873 A) discloses a communication system in which a plurality of server devices and a plurality of device terminals are communicably connected to each other via a wide area network.
Patent Document 2 (JP 2020-187466 A) discloses a server, a personal computer, and an access point as an exemplary edge computer arranged between a cloud server and a device.

In the related technique disclosed in JP 2017-146873 A, a request is transmitted from a cloud server to an edge computer connected to an IoT device each time an instruction is given to the IoT device. A large amount of communication data is exchanged between the cloud server and the edge computer. As a result, the load on the side of the cloud server becomes excessive, which causes resource shortage and processing delay.

### SUMMARY

The present invention has been conceived in view of the problems described above, and an object thereof is to reduce occurrence of resource shortage and processing delay.

### BRIEF DESCRIPTION OF THE DRAWINGS

Exemplary features and advantages of the present invention will become apparent from the following detailed description when taken with the accompanying drawings in which:

FIG. 1 is a diagram schematically illustrating an exemplary configuration of a communication system to which a communication control device according to a first or second example embodiment is applied;

FIG. 2 is a block diagram illustrating a configuration of the communication control device according to the first example embodiment;

FIG. 3 is a flowchart illustrating operation of the communication control device according to the first example embodiment;

FIG. 4 is a block diagram illustrating a configuration of the communication control device according to the second example embodiment;

FIG. 5 is a diagram illustrating contents of information stored in a storage unit included in the communication control device according to the second example embodiment;

FIG. 6 is a flowchart illustrating operation of the communication control device according to the second example embodiment;

FIG. 7 is a block diagram illustrating an exemplary configuration of an edge computer that communicates with the communication control device according to the second example embodiment; and

FIG. 8 is a diagram illustrating an exemplary hardware configuration of the communication control device according to the first or second example embodiment.

### EXAMPLE EMBODIMENT

Some example embodiments of the present invention will be described below with reference to the accompanying drawings.

### Common to all Example Embodiments

An exemplary communication system to which a communication control device 10 according to a first example embodiment or a communication control device 20 according to a second example embodiment to be described later is applied will be described. In the following descriptions, the “communication control device 10 or communication control device 20” will be referred to as a “communication control device 10 (20)”.

(Communication System 1)

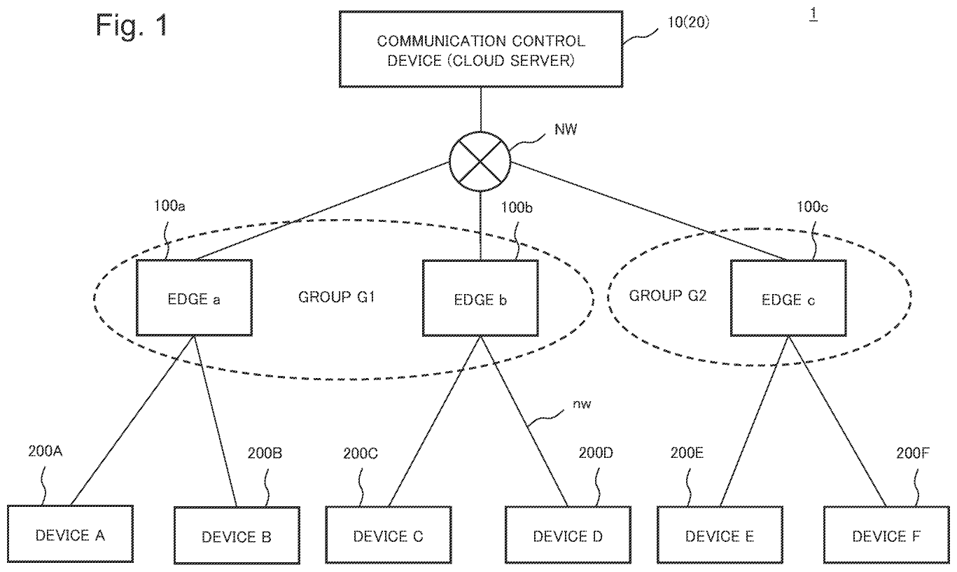

FIG. 1 is a diagram schematically illustrating an exemplary configuration of a communication system 1 to which the communication control device 10 (20) according to the first or second example embodiment to be described later is applied. As illustrated in FIG. 1, the communication system 1 includes the communication control device 10 (20), edge computers 100a to 100c (indicated as “edges a to c” in FIG. 1), and Internet of Things (IoT) devices 200A to 200F (indicated as “devices A to F” in FIG. 1).

In the example illustrated in FIG. 1, the communication system 1 includes the three edge computers 100a to 100c and the six IoT devices 200A to 200F. However, the number of the edge computers and IoT devices may differ from this example. In addition, one or more IoT devices may be connected to one edge computer.

The communication control device 10 (20) controls communication in the entire communication system 1. Specifically, the communication control device 10 (20) controls exchange of communication data generated in a wide area network NW and a narrow area network nw. The wide area network NW connects the communication control device 10 (20) and the edge computers 100a to 100c in a communicable manner. On the other hand, the narrow area network nw connects the edge computers 100a to 100c and the IoT devices 200A to 200F in a communicable manner. Here, the communication control device 10 (20) is assumed to be a cloud server placed on the wide area network NW.

The edge computers 100a to 100c are disposed between the communication control device 10 (20) and the IoT devices 200A to 200F on a network constructed by the communication system 1. The edge computers 100a to 100c control the IoT devices 200A to 200F on the basis of instructions from the communication control device 10 (20). Furthermore, the edge computers 100a to 100c process the data obtained from the IoT devices 200A to 200F, and then transmit the processed data to the communication control device 10 (20).

In one example, the edge computers 100a to 100c are intermediate servers that partially implement the function of the cloud server. For example, the edge computers 100a to 100c are personal computers, gateway devices, or access points.

The IoT devices 200A to 200F uses what is called IoT technology to connect to a network and communicate with an external device such as a server. In the communication system 1 illustrated in FIG. 1, the IoT devices 200A to 200F are connected to the edge computers 100a to 100c via the narrow area network nw. For example, the IoT devices 200A to 200F are sensors, cameras, microphones, monitors, air conditioners, lamps, or any electronic devices.

In some example embodiments to be described below, a configuration of the communication control device to be applied to the communication system 1 will be described. Note that the configuration of the communication system 1 illustrated in FIG. 1 is merely an example. The communication control device 10 (20) according to the first or second example embodiment to be described later may also be applied to a system other than the communication system 1.

### First Example Embodiment

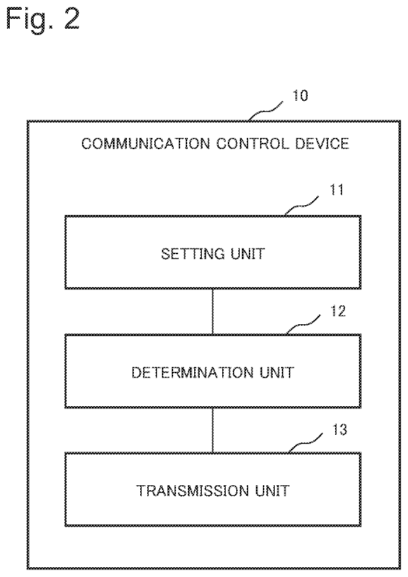

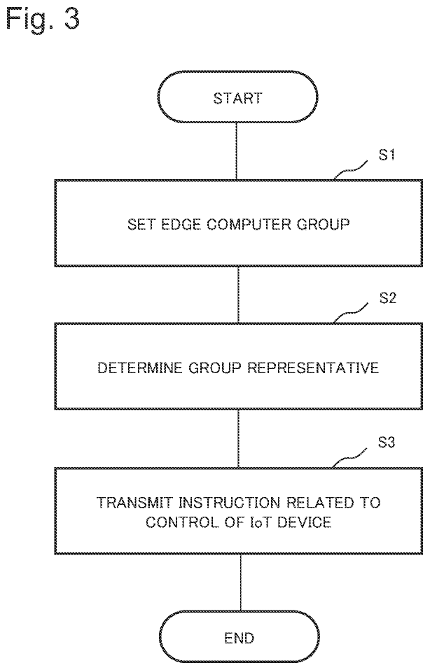

The first example embodiment will be described with reference to FIGS. 2 and 3.

(Communication Control Device 10)

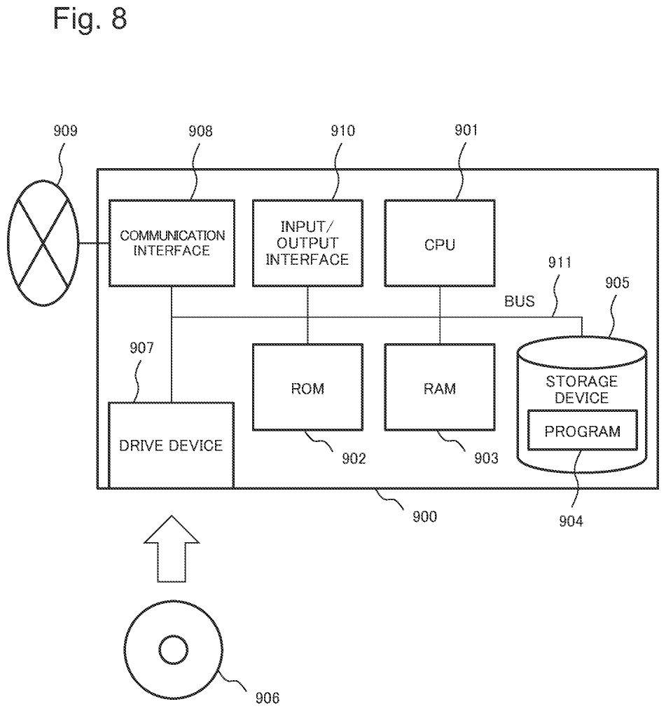

FIG. 2 is a block diagram illustrating a configuration of the communication control device 10 according to the present first example embodiment. As illustrated in FIG. 2, the communication control device 10 includes a setting unit 11, a determination unit 12, and a transmission unit 13. The communication control device 10 may be achieved by a hardware device including a processor and a memory, which is, for example, an information processing apparatus 900 (computer device) illustrated in FIG. 8 to be described later.

The setting unit 11 sets a group including one or more edge computers (edge computers 100a to 100c in the case of FIG. 1). The setting unit 11 is an exemplary setting means. In the communication system 1 illustrated in FIG. 1, two groups, that is, a group G1 including the edge computers 100a and 100b and a group G2 including only the edge computer 100c are set.

In one example, the setting unit 11 sets a group of the edge computers using a priority level, a limit of communication data volume, and/or information associated with network settings.

The priority level indicates in what order the communication between the communication control device 10 and each edge computer is prioritized. The setting unit 11 may change the priority level depending on a state of the IoT device (IoT devices 200A to 200F in the case of FIG. 1) connected to the edge computer or a situation such as a time period.

The communication data volume indicates data traffic accepted by the communication system 1 (FIG. 1). The setting unit 11 sets a group of the edge computers in such a manner that the communication between the communication control device 10 and the representative edge computer does not exceed the data traffic accepted by the communication system 1.

The network settings define communication rules within the communication system 1. The information associated with the network settings may include the priority level and the limit of the communication data volume described above. The information associated with the network settings may be manually input by a user in advance. In the manual input, for example, an input/output interface 910 of the information processing apparatus 900 illustrated in FIG. 8 may input the information associated with the network settings from an input device (not illustrated).

In another example, the setting unit 11 refers to list information of the edge computers stored in a storage device (not illustrated). The list information of the edge computers indicates a list of the edge computers communicably connected to the communication control device 10. The setting unit 11 classifies the edge computers listed in the list information into one or more groups in such a manner that each edge computer is always included in a single group. The “included” here has the meaning same as “belongs to”.

In another example, the setting unit 11 refers to group information of the edge computers stored in a storage device (not illustrated). The group information of the edge computers indicates edge computers included in the same group. The setting unit 11 sets a group including one or more edge computers on the basis of the group information. The group information of the edge computers may be manually input by the user in advance.

The setting unit 11 outputs information indicating the set group to the determination unit 12. The information indicating the group includes information for identifying the edge computer included in the group.

The determination unit 12 determines one of the edge computers included in the group as a representative of the group. The determination unit 12 is an exemplary determination means.

In one example, the determination unit 12 receives, from the setting unit 11, information indicating a group including one or more edge computers. The determination unit 12 determines one edge computer among the edge computers included in the group as a representative using any method. For example, the determination unit 12 randomly determines one edge computer among the edge computers included in the group as a representative.

In another example, the determination unit 12 refers to group information of the edge computers stored in a storage device (not illustrated). Then, the determination unit 12 determines, as a representative, an edge computer to which the smallest identification number is assigned among the edge computers included in the group.

Next, the determination unit 12 obtains information indicating a network address of the representative edge computer. For example, the determination unit 12 refers to information associated with the edge address of the representative from a storage device (not illustrated) to obtain the information indicating the network address of the representative edge computer.

The determination unit 12 transmits the information indicating the network address of the representative edge computer to the transmission unit 13. Alternatively, the determination unit 12 may transmit information for identifying the representative edge computer (e.g., identification number) to the transmission unit 13. In this case, the transmission unit 13 identifies the network address of the representative edge computer on the basis of the list information of the edge computers stored in the storage device (not illustrated).

The transmission unit 13 transmits, to the representative edge computer, an instruction related to control of the IoT device connected to the edge computer include in the group. The transmission unit 13 is an exemplary transmission means.

In one example, the transmission unit 13 receives, from the determination unit 12, the information indicating the network address of the representative edge computer. The transmission unit 13 transmits an instruction related to control of the IoT device connected to one or more edge computers to the network address of the representative edge computer via the wide area network NW (FIG. 1).

(Operation of Communication Control Device 10)

Operation of the communication control device 10 according to the present first example embodiment will be described with reference to FIG. 3. FIG. 3 is a flowchart illustrating a flow of a process to be executed by each unit of the communication control device 10. In a case where the communication control device 10 is the information processing apparatus 900 (FIG. 8), the process illustrated in the flowchart of FIG. 3 is a process based on a program 904 stored in a storage device 905 and loaded into a random access memory (RAM) 903. The process is executed by a central processing unit (CPU) 901.

The list information of the edge computers, and the list information of the IoT devices are stored in a storage device (not illustrated) in advance. The list information of the edge computers may be manually input by the user in advance. The list information of the IoT devices may be input from the edge computer connected to the IoT devices. For example, the list information of the IoT devices may be input from the edge computer via a communication interface 908 of the information processing apparatus 900 illustrated in FIG. 8. Furthermore, the user inputs the contents of the instruction related to control of the IoT device connected to the edge computer to the communication control device 10 via, for example, the input/output interface 910.

As illustrated in FIG. 3, the setting unit 11 sets a group including one or more edge computers (S1). The setting unit 11 outputs group information indicating the set group to the determination unit 12.

Next, the determination unit 12 determines one of the edge computers included in the group as a representative of the group (S2). The determination unit 12 transmits the information indicating the network address of the representative edge computer to the transmission unit 13.

The transmission unit 13 transmits, to the representative edge computer, an instruction related to control of the IoT device connected to one or more edge computers on the basis of the group information of the edge computers and the information indicating the network address of the representative edge computer (S3). The group information of the edge computers is used by the representative edge computer to transfer the instruction to another edge computer (i.e., non-representative edge computer) included in the group.

The operation of the communication control device 10 according to the present first example embodiment is terminated as above.

### Effects of Present Example Embodiment

According to the configuration of the present example embodiment, the setting unit 11 sets a group including one or more edge computers. The determination unit 12 determines one of the edge computers included in the group as a representative of the group. The transmission unit 13 transmits an instruction related to control of the IoT device to the representative edge computer.

As described above, the instruction related to control of the IoT device connected to the edge computer included in the group is transmitted to the representative edge computer of the group. As a result, since it is not required to transmit the instruction request to all the edge computers included in the group, it becomes possible to reduce occurrence of resource shortage and processing delay.

### Second Example Embodiment

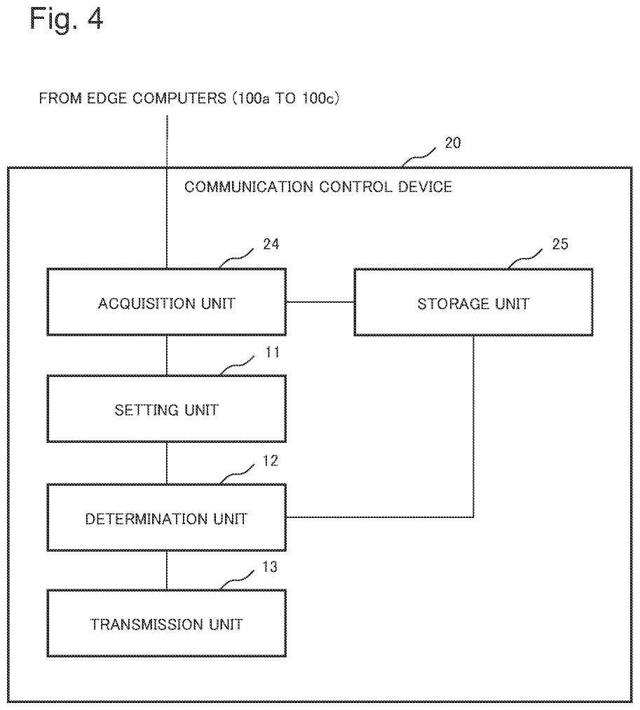

A second example embodiment will be described with reference to FIGS. 4 to 6. In the present second example embodiment, configurations described in the first example embodiment are denoted by the reference signs same as those in the first example embodiment, and descriptions thereof will be omitted.

(Communication Control Device 20)

FIG. 4 is a block diagram illustrating a configuration of a communication control device 20 according to the present second example embodiment. As illustrated in FIG. 4, the communication control device 20 includes a setting unit 11, a determination unit 12, and a transmission unit 13. The communication control device 20 further includes an acquisition unit 24 and a storage unit 25. The communication control device 20 may be achieved by a hardware device including a processor and a memory, which is, for example, an information processing apparatus (computer device) illustrated in FIG. 8 to be described later.

The acquisition unit 24 obtains, from an edge computer, information for identifying an IoT device (IoT devices 200A to 200F in the case of FIG. 1) connected to the edge computer (edge computers 100a to 100c in the case of FIG. 1). The acquisition unit 24 is an exemplary acquisition means. List information includes information for identifying the IoT device.

In one example, the acquisition unit 24 obtains information (e.g., identification number) for identifying the IoT device connected to the edge computer from each edge computer included in a group.

The acquisition unit 24 periodically obtains the information for identifying the IoT device connected to each of the edge computers from all the edge computers connected to the communication control device 20 via a wide area network NW (FIG. 1). Alternatively, each time an IoT device connected to a certain edge computer is added or changed, the acquisition unit 24 may obtain the information for identifying the IoT device connected to the edge computer.

The acquisition unit 24 outputs, to the storage unit 25, the information for identifying the IoT device connected to the edge computer together with information for identifying the edge computer.

The storage unit 25 stores list information of the IoT devices connected to the edge computer. The storage unit 25 is an exemplary storage means. For example, the storage unit 25 is a RAM 903 or a storage device 905 of an information processing apparatus 900 illustrated in FIG. 8.

In one example, the storage unit 25 receives, from the acquisition unit 24, the information for identifying the IoT device connected to the edge computer together with the information for identifying the edge computer. The storage unit 25 generates list information of the edge computers and list information of the IoT devices from the received information, and stores them.

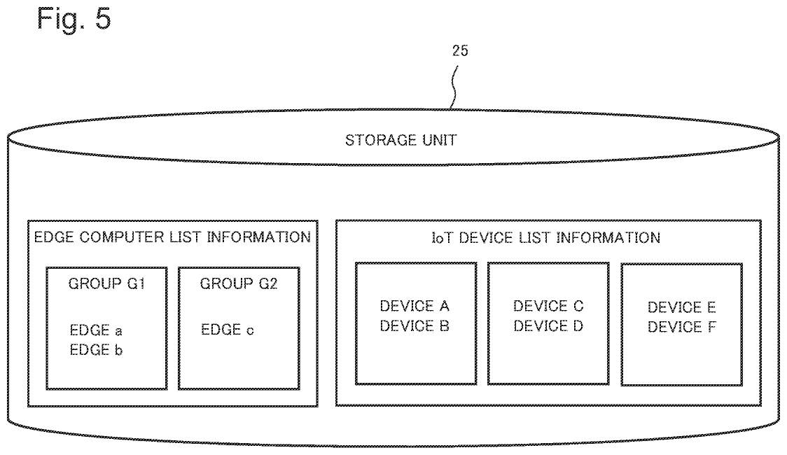

FIG. 5 illustrates exemplary information stored in the storage unit 25. In the example of FIG. 5, the storage unit 25 stores, in addition to the list information of the edge computers 100a to 100c (indicated as “edge a”, “edge b”, and “edge c” in FIG. 5), the list information of the IoT devices 200A to 200F (indicated as “devices (A to F)” in FIG. 5) connected to the edge computers 100a to 100c.

In the example illustrated in FIG. 5, the edge computers 100a to 100c are classified into groups G1 and G2. The group G1 includes the edge computer 100a and the edge computer 100b. The group G2 includes the edge computer 100c.

In the present second example embodiment, the determination unit 12 refers to the list information (FIG. 5) of the edge computers stored in the storage unit 25. Then, the determination unit 12 determines a representative edge computer of the group on the basis of the list information of the edge computers. For example, the determination unit 12 determines, as a representative, an edge computer to which the smallest identification number is assigned among the edge computers included in the group.

Furthermore, in the present second example embodiment, the transmission unit 13 refers to the list information of the IoT devices stored in the storage unit 25 to identify the destination IoT device to which the instruction is transmitted.

(Operation of Communication Control Device 20)

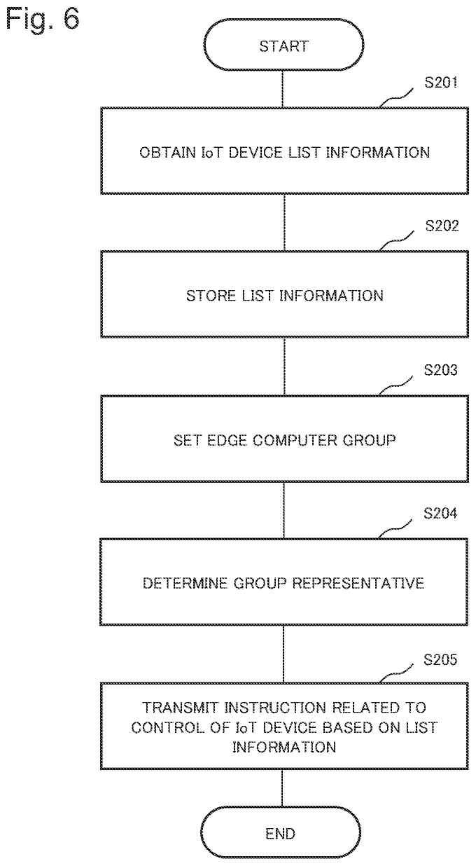

Operation of the communication control device 20 according to the present second example embodiment will be described with reference to FIG. 6. FIG. 6 is a flowchart illustrating a flow of a process to be executed by each unit of the communication control device 20.

First, the user inputs the contents of the instruction related to control of the IoT device connected to the edge computer to the communication control device 20.

As illustrated in FIG. 6, the acquisition unit 24 obtains, from the edge computer, the list information of the IoT devices connected to the edge computer (S201). The acquisition unit 24 outputs the list information of the IoT devices connected to the edge computer to the storage unit 25.

The storage unit 25 stores the list information of the IoT devices connected to the edge computer (S202).

Subsequently, the setting unit 11 refers to the list information of the edge computers stored in the storage unit 25, and sets a group including one or more edge computers (S203). The setting unit 11 outputs group information indicating the set group to the determination unit 12.

Next, the determination unit 12 determines one of the edge computers included in the group as a representative of the group (S204). The determination unit 12 transmits the information indicating the network address of the representative edge computer to the transmission unit 13.

The transmission unit 13 transmits, to the representative edge computer, an instruction related to control of the IoT device connected to one or more edge computers on the basis of the group information of the edge computers and the information indicating the network address of the representative edge computer (S205).

The operation of the communication control device 20 according to the present second example embodiment is terminated as above.

(Variations)

In one variation, steps S201 to S202 and steps S203 to S205 are executed separately. In the present variation, steps S201 to S202 are executed each time an IoT device connected to the edge computer is added or changed. Meanwhile, steps S203 to S205 are executed periodically or at any timing.

### Effects of Present Example Embodiment

According to the configuration of the present example embodiment, the setting unit 11 sets a group including one or more edge computers. The determination unit 12 determines one of the edge computers included in the group as a representative of the group. The transmission unit 13 transmits an instruction related to control of the IoT device to the representative edge computer.

As described above, the instruction related to control of the IoT device connected to the edge computer included in the group is transmitted to the representative edge computer of the group. As a result, since it is not required to transmit the instruction request to all the edge computers included in the group, it becomes possible to reduce occurrence of resource shortage and processing delay.

Furthermore, according to the configuration of the present example embodiment, the acquisition unit 24 obtains the list information of the IoT devices connected to the edge computer from the edge computer. The storage unit 25 stores the list information of the IoT devices. As a result, the transmission unit 13 is enabled to identify the destination IoT device to which the instruction is transmitted by referring to the list information of the IoT devices stored in the storage unit 25.

(Configuration of Edge Computers 100a to 100c)

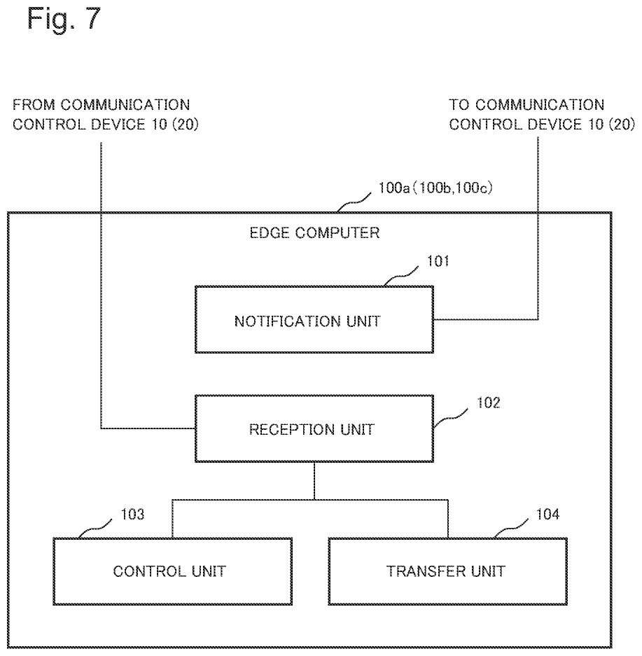

An exemplary configuration of the edge computers 100a to 100c included in the communication system 1 (FIG. 1) will be described with reference to FIG. 7. FIG. 7 is a block diagram illustrating an exemplary configuration of the edge computers 100a to 100c.

As illustrated in FIG. 7, each of the edge computers 100a to 100c includes a notification unit 101, a reception unit 102, a control unit 103, and a transfer unit 104.

Hereinafter, only a configuration of the edge computer 100a will be described. A configuration of the edge computer 100b and edge computer 100c is the same as that of the edge computer 100a.

The notification unit 101 notifies the communication control device 10 (20) of information for identifying the IoT devices 200A to 200B connected to the edge computer 100a. The notification unit 101 is an exemplary notification means. In one example, the notification unit 101 transmits the information for identifying the IoT devices 200A to 200B connected to the edge computer 100a to the communication control device 10 (20) via the wide area network NW (FIG. 1).

In a case where the edge computer 100a is a representative of the group G1 (FIG. 1), the reception unit 102 receives an instruction related to control of the IoT devices 200A to 200F from the communication control device 10 (20). The reception unit 102 outputs, to the control unit 103, the instruction related to control of the IoT devices 200A to 200F.

On the other hand, in a case where the edge computer 100a is not the representative of the group G1, the instruction related to control of the IoT devices 200A to 200F is received from the edge computer 100b, which is the representative of the group G1. The reception unit 102 outputs the instruction related to control of the IoT devices 200A to 200F to both the control unit 103 and the transfer unit 104. The reception unit 102 is an exemplary reception means.

The control unit 103 receives, from the reception unit 102, the instruction related to control of the IoT devices 200A to 200F. The control unit 103 executes the control of the IoT devices 200A to 200B connected to the edge computer 100a in accordance with the instruction related to control of the IoT devices 200A to 200F. The control unit 103 is an exemplary control means. The control here indicates, for example, ON/OFF switching of a sensor, a direction change of a camera, and adjustment of air conditioning.

In a case where the edge computer 100a is not the representative of the group G1, the transfer unit 104 receives the instruction related to control of the IoT devices 200A to 200F from the reception unit 102. The transfer unit 104 transfers the instruction to another edge computer 100b included in the group G1. The transfer unit 104 is an exemplary transfer means.

(Hardware Configuration)

Each component of the communication control device 10 (20) described in the first and second example embodiments indicates a block in a functional unit. Some or all of those components are achieved by, for example, the information processing apparatus 900 as illustrated in FIG. 7. FIG. 7 is a block diagram illustrating an exemplary hardware configuration of the information processing apparatus 900.

As illustrated in FIG. 7, the information processing apparatus 900 includes the following configurations as an example.
CPU 901
ROM (Read Only Memory) 902
RAM 903
Program 904 to be loaded into the RAM 903
Storage device 905 that stores the program 904
Drive device 907 that performs reading/writing on a recording medium 906
Communication interface 908 that connects to a communication network 909
Input/output interface 910 that inputs/outputs data
Bus 911 that connects components

Each component of the communication control device 10 (20) described in the first and second example embodiments is achieved by the CPU 901 reading and executing the program 904 for implementing those functions. The program 904 for implementing the function of each component is stored in, for example, the storage device 905 or the ROM 902 in advance, and is loaded by the CPU 901 into the RAM 903 to be executed as needed. The program 904 may be supplied to the CPU 901 via the communication network 909, or may be stored in the recording medium 906 in advance so that the drive device 907 reads the program to supply it to the CPU 901.

According to the configuration as described above, the communication control device 10 (20) described in the first and second example embodiments is achieved as hardware. Therefore, it becomes possible to exert effects similar to the effects described in the example embodiment described above.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A communication control device comprising:
a setting means configured to set a group including one or more edge computers;
a determination means configured to determine one of the one or more edge computers included in the group as a representative of the group; and
a transmission means configured to transmit, to the representative edge computer, an instruction related to control of an IoT device connected to the one or more edge computers included in the group.

2. The communication control device according to claim 1, wherein
the transmission means also transmits, to the representative edge computer, information that identifies the one or more edge computers included in the group.

3. The communication control device according to claim 1, further comprising:
an acquisition means configured to obtain, from the one or more edge computers, information that identifies the IoT device connected to the one or more edge computers included in the group; and
a storage means configured to store list information of the IoT device.

4. The communication control device according to claim 3, wherein
the transmission means identifies a destination IoT device to which the instruction is transmitted by referring to the list information.

5. The communication control device according to claim 3, wherein
the storage means stores list information of the one or more edge computers included in the group.

6. The communication control device according to claim 5, wherein
the determination means determines the representative edge computer based on the list information of the one or more edge computers.

7. A communication system comprising:
the communication control device according to claim 1;
the one or more edge computers included in the group; and
the IoT device connected to the one or more edge computers included in the group.

8. The communication system according to claim 7, wherein
the one or more edge computers include:
a notification means configured to notify the communication control device of information that identifies the IoT device connected to the one or more edge computers;
a receiving means configured to receive the instruction related to control of the IoT device from the communication control device or from the representative edge computer of the group;
a control means configured to execute the control of the IoT device connected to the one or more edge computers in accordance with the instruction; and
a transfer means configured to transfer the instruction to the representative edge computer of the group in a case where the instruction is received from the communication control device.

9. A communication control method that causes a computer to perform:
setting a group including one or more edge computers;
determining one of the one or more edge computers included in the group as a representative of the group; and
transmitting, to the representative edge computer, an instruction related to control of an IoT device connected to the one or more edge computers.

10. A non-transitory recording medium storing a program for causing a computer to perform a process comprising:
setting a group including one or more edge computers;
determining one of the one or more edge computers included in the group as a representative of the group; and
transmitting, to the representative edge computer, an instruction related to control of an IoT device connected to the one or more edge computers.
